(19) United States
(12) Patent Application Publication
(10) Pub. No.: US 2013/0014711 A1
(43) Pub. Date: Jan. 17, 2013

(54) METHOD AND SYSTEM FOR OPERATING A COMPRESSION IGNITION ENGINE

(71) Applicants: Ton V.W. Janssens, Bagsvaerd (DK); Svend-Erik Mikkelsen, Vaerlose (DK); Pär L.T. Gabrielsson, Helsingborg (SE)

(72) Inventors: Ton V.W. Janssens, Bagsvaerd (DK); Svend-Erik Mikkelsen, Vaerlose (DK); Pär L.T. Gabrielsson, Helsingborg (SE)

(73) Assignee: Haldor Topsoe A/S, Kgs. Lyngby (DK)

(21) Appl. No.: 13/638,215

(22) PCT Filed: Mar. 2, 2011
(86) PCT No.: PCT/EP2011/001019

§ 371 Date: Sep. 28, 2012

(30) Foreign Application Priority Data
Mar. 31, 2010 (DK) PA2010 00273
Jul. 2, 2010 (DK) PA2010 00587
Jul. 5, 2010 (DK) PA2010 00590

(51) Int. Cl. F02B 51/02; F02M 27/02

(52) U.S. Cl. 123/3

(57) ABSTRACT

A method of operating a compression ignition engine on diethyl ether containing fuel obtained by conversion of a primary ethanol containing fuel, wherein the primary fuel is catalytically converted to a diethyl ether containing fuel at a constant minimum and maximum flow rate through a catalytic reactor. The thus prepared ether containing fuel is passed to a buffer tank and a system for use in anyone of the preceding claims comprising a first fuel tank for holding a primary ethanol containing fuel; an ethanol dehydration reactor connected to the first fuel tank at inlet of the reactor and to a second buffer tank connected at outlet of the reactor; the second buffer tank holding a diethyl ether containing fuel being formed in the dehydration reactor is further connected to a compression ignition engine; the second buffer tank is provided with at least a sensor for detecting an upper fuel level and at least a second sensor for detecting a lower fuel level in the buffer tank.

The present invention is directed to a method of operating a compression ignition engine. In particular, the invention provides a method and system for the preparation of a diethyl ether containing diesel fuel from a primary ethanol fuel for use in the operation of the compression ignition engine.

The most typical example of a compression ignition engine is the Diesel engine operating with a high cetane number Diesel fuel. To reduce environmental pollution arising from combustion of Diesel fuel, several attempts have been made in the past to replace Diesel fuel with alternative fuels having reduced impact on the environment.

Ethanol produced from biological or waste sources will be of increasing importance as an energy source for transportation in the near future. However, new technologies are needed to use this energy source efficiently.

Use of lower ethers prepared by dehydration of alcohols as Diesel fuel has been described in number of publications, e.g. U.S. Pat. Nos. 4,892,561; 5,906,664 and 7,449,034.

Despite of its clean combustion characteristics and high efficiency in a Diesel engine, the main disadvantage of ether based fuels is difficult storage and handling on board of vehicles. At ambient conditions, dimethyl ether is in the gaseous form. To transform the dimethyl ether fuel to its more convenient liquid form, the fuel has to be stored and handled under pressure.

Though diethyl ether is in the liquid form at ambient conditions, this ether has a high vapour pressure and has a high risk of explosion when in contact with air.

To avoid the above problems, in particular when using diethyl ether as diesel fuel on board of a car, this invention is based in general on employing a primary fuel containing ethanol and catalytic dehydrating ethanol contained in the primary fuel on-board of the car to a diethyl ether containing diesel fuel. Consequently, a car contains only a limited amount of diethyl ether at a time, and the fuel distribution system uses ethanol, which is much safer to transport than diethyl ether.

When employing catalytic dehydration of primary alcohol, such as ethanol the problem arises that the dehydration rate and flow rate of the primary fuel to a catalytic dehydration reactor must be adapted to the momentary actual consumption of the ether containing fuel in the engine.

The conversion of ethanol to ether is an exothermal equilibrium reaction. Consequently, the reaction temperature in the reactor and the catalyst will dependent on the flow rate of alcohol through the reactor. At a high consumption rate of the ether fuel, the throughput rate of the primary alcohol fuel through the reactor needs to be accordingly high causing an increase of the reaction temperature to levels, which result in increased formation of unwanted byproducts.

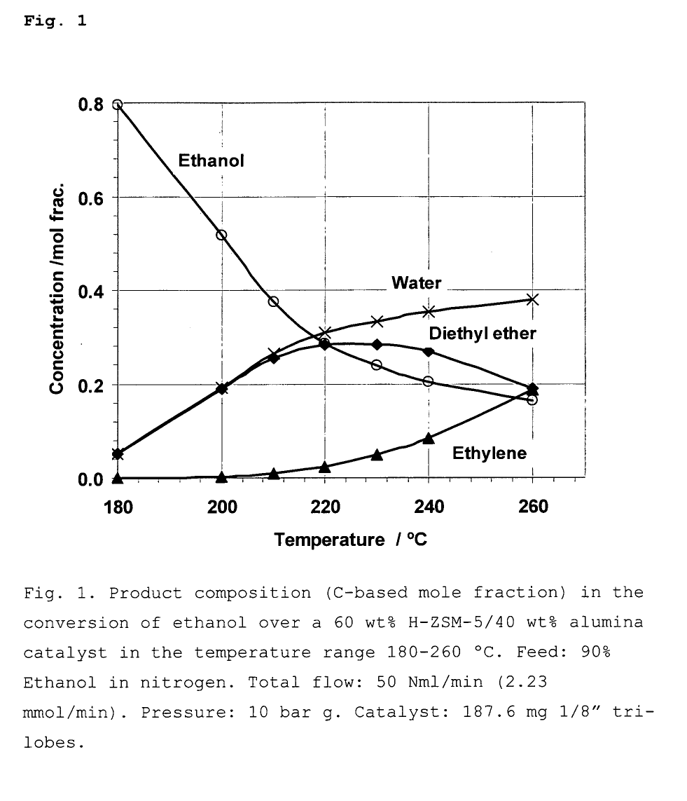

A by-product of the catalytic conversion of ethanol to ether is ethylene. Ethylene is always observed in a small amount on the order of a few percent in the conversion of ethanol at low temperature range 200-240° C., but becomes significant at higher temperatures (see FIG. 1). A small amount of ethylene has little effect on the fuel quality, but a large amount is detrimental, since ethylene is not suitable as a diesel fuel. The production of ethylene is possibly also a sign that coke is being deposited on the catalyst causing deactivation. As a consequence, it is important to control the temperature in the catalytic dehydration reactor in order to minimize the formation of ethylene.

To solve the above discussed problems, this invention provides in its broadest embodiment a method of operating a compression ignition engine on

diethyl ether containing fuel obtained by conversion of a primary ethanol containing fuel comprising the steps of:
(a) withdrawing the primary ethanol containing fuel from a first fuel tank;
(b) introducing the primary ethanol containing fuel at a predetermined constant maximum flow rate into a reaction chamber with an alcohol dehydration catalyst;
(c) dehydrating the primary ethanol containing fuel to a diethyl ether containing fuel;
(d) passing the diethyl ether containing fuel to a second buffer tank up to a predetermined upper fuel level and interrupting introduction or reducing the flow rate of the primary ethanol containing fuel into the reaction chamber to a constant minimum flow rate being lower than the maximum flow rate when the upper fuel level in the reaction chamber is reached;
(e) withdrawing the diethyl ether containing fuel from the second buffer tank and injecting the diethyl ether fuel into the engine and emptying the second buffer tank to the predetermined lower fuel level
(f) restarting introduction or re-establishing the constant maximum flow rate of the primary ethanol containing fuel into the reaction chamber when the predetermined lower fuel level is reached.

The dehydration of alcohols to ethers is catalyzed by acidic materials being known in the art, like solid-acid catalyst including γ-alumina, modified-alumina with silica and phosphorus, Al₂O₃—B₂O₃, sulphated or tungstated metal oxides (such as sulphated or tungstated zirconia, tin oxide), materials containing sulfonic acid groups and molecular sieves materials (chabazites, mordenites, SAPOs) or zeolites.

The term “constant flow rate” mentioned hereinbefore and in the following description and claims refers to a rate at which the primary ethanol fuel passed is to the reactor.

In an embodiment of the invention the operation of the reaction chamber and buffer tank comprises the following steps:

introducing the primary ethanol containing fuel at a predetermined maximum constant flow rate of at least 70% of a peak fuel consumption into the reaction chamber containing an alcohol dehydration catalyst;
dehydrating the primary ethanol fuel to a diethyl ether containing fuel;
passing the diethyl ether containing fuel to the buffer tank up to the predetermined upper fuel level
(e) reducing the flow rate of the primary ethanol containing fuel to a predetermined constant minimum flow rate between of 0 to 30% of the peak fuel consumption, when the upper feed level in the reaction chamber is reached;
(f) emptying the buffer tank to the predetermined lower fuel level;
(g) restarting introduction or re-establishing the first constant flow rate of the primary ethanol fuel into reaction chamber when the predetermined lower fuel level is reached, and repeating the procedure.

The “peak fuel consumption” of the engine is defined as the maximum value for the time averaged fuel consumption over a time period of one minute, which is calculated as the amount of fuel (in g or kg) in the buffer tank at any given point in time minus the amount of fuel (in g or kg) in the tank one minute before that particular point in time, and multiplication by 60 to convert to g/h or kg/h. The required data for the fuel consumption may be generated in an appropriate laboratory test run for the compression ignition engine or by a measurement in the application of the compression ignition engine such as a car or a stationary power generator.

The part of the system comprising the primary fuel tank, the reaction chamber and the buffer tank have the following parameters, which have to be adjusted to the peak fuel consumption of the engine: storage capacity of the buffer tank, high fuel level in the buffer tank, low fuel level in the buffer tank, reactor volume, catalyst amount, reactor operating temperature, reactor operating pressure, first constant flow rate (in kg or litre per hour), second constant flow rate (in kg or litre per hour).

The term “storage capacity of the buffer tank” refers to the total amount of fuel that can be contained in the buffer tank.

The “high fuel level” refers to the predetermined fuel content in the buffer tank at which the reactor operation is changed from the high constant flow rate to the low constant flow rate.

The “low fuel level” refers to the predetermined fuel content in the buffer tank at which the reactor operation is changed from the low constant flow rate to the high constant flow rate.

The buffer tank allows the reactor to be run under predictable conditions, eliminating the fluctuations in fuel demand of the engine from the operation of the reactor. An additional advantage is that certain additives required for the engine can be added in the buffer tank instead of the primary fuel tank, and therefore do not affect the performance of the catalyst in the reactor.

It is conceivable to design a system making use of more than two flow levels in the reactor, e.g. by introducing a medium flow, which is 50% of the peak fuel consumption, which could be applied for filling the buffer tank while the fuel demand of the engine is low. Although this in principle can result in a more precise control of the reactor, it is necessary also to apply a predefined flow in the regions indicated above in order to use the engine for a prolonged time under high fuel demand conditions (e.g. a long motorway journey) or under low fuel demand conditions (e.g. a longer drive in an urban area).

The invention provides furthermore a system for use in the method according to the invention comprising a first fuel tank for holding a primary ethanol containing fuel;

an ethanol dehydration reactor connected to the first fuel tank at inlet of the reactor and to a second buffer tank connected at outlet of the reactor;
the second buffer tank holding a diethyl ether containing fuel being formed in the dehydration reactor is further connected to a compression ignition engine;
the second buffer tank is provided with at least a sensor for detecting an upper fuel level and at least a second sensor for detecting a lower fuel level in the buffer tank.

### EXAMPLE 1

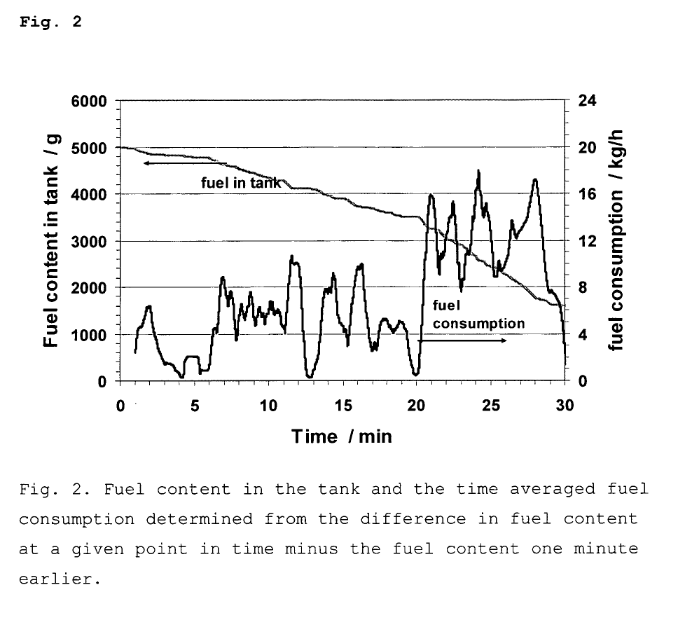

This example shows how to determine the peak fuel consumption of the engine using data obtained in a standard engine test run that lasted 30 minutes. In the present example, the consumption of conventional diesel fuel (in kg per hour) was measured every 0.1 s. This fuel consumption was multiplied by 1.5 to correct for the lower combustion heat of ethanol resulting in an expected consumption of an ethanol-based fuel. The grey line in FIG. 2 shows the fuel content in the tank during the test that is calculated from these data. The black line indicates the time averaged fuel consumption during this test calculated from the difference in fuel content at a given point in time minus the fuel content one minute earlier. The peak fuel consumption is the maximum in this curve and amounts to 18 kg/h, which occurs at 24.2 min in the test.

### EXAMPLE 2

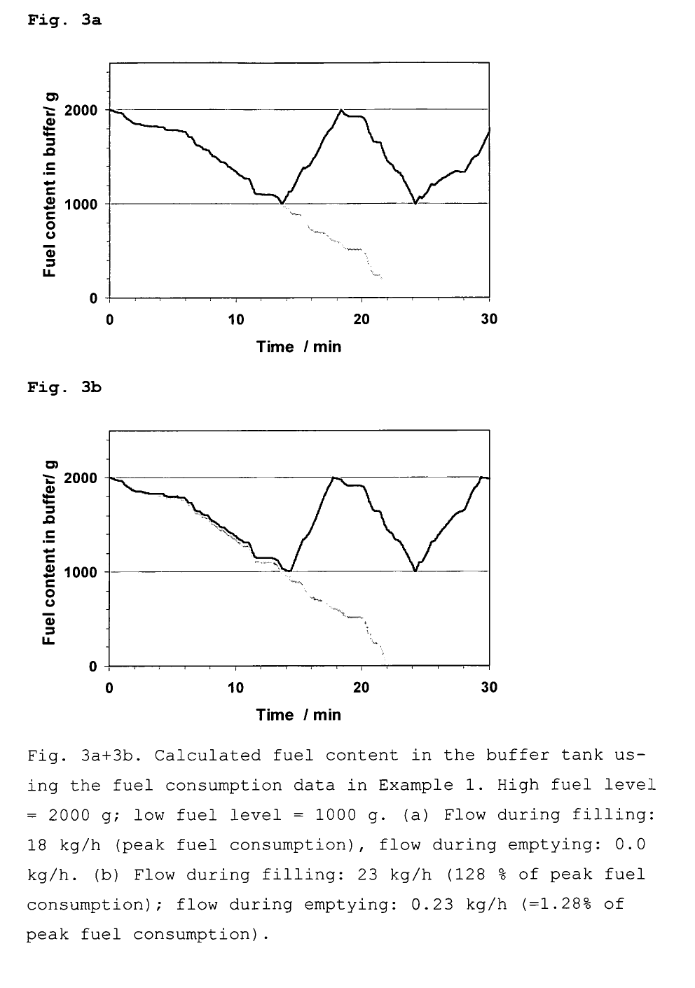

This example illustrates the principle of operation of the invention. A buffer tank with a high fuel level of 2000 g and a low fuel level of 1000 g is assumed, and the same fuel consumption data as in Example 1 are used. The predefined flow during filling of the buffer tank is assumed to be equal to the peak fuel consumption (18.0 kg/h); the predefined flow during emptying the buffer tank is set to 0% (0.0 kg/h) of the peak fuel consumption or interrupted flow. The initial amount of fuel in the buffer tank is chosen to 2000 g, which implies that the reactor is initially run with a flow of 0.0 kg/h. FIG. 3a shows the calculated amounts of fuel in the buffer tank with a reactor operation as disclosed in the invention using these specific values. We find that the buffer tank is emptied with the flow of 0.0 kg/h from 0 to 13.6 min. and from 18.4 to 24.3 min. From 13.6 min to 18.4 min. and from 24.3 to 30.0 min. the flow is set to 18.0 kg/h, and the reactor is filled in these time intervals. As a reference, the grey curve shows the fuel the buffer tank would have without refilling, in which case one would run out of fuel just after 21 min. in this example. FIG. 3b shows the operation with a flow of 23.0 kg/h during filling of the buffer tank and a flow of 0.23 kg/h during emptying the buffer tank, which results in essentially the same operation.

### EXAMPLE 3

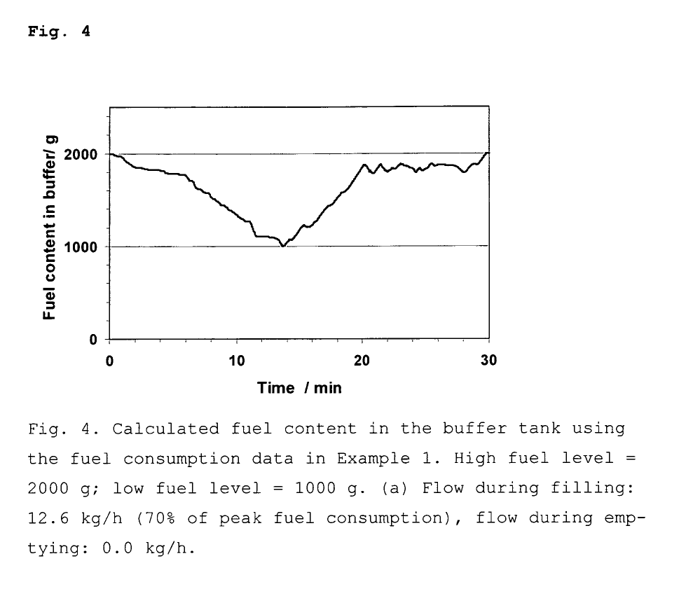

This example explores a lower limit for the flow during filling of the buffer tank. FIG. 4 shows the calculated fuel content in a buffer as mentioned above using a constant flow rate of 12.6 kg/h, corresponding to 70% of the peak fuel consumption determined in Example 1. The initial amount of fuel in the buffer tank is 2000 g; during emptying the buffer tank the flow is set to 0.0 kg/h (interrupted flow). Clearly, in the period between 20 and 29 min. the fuel content in the buffer tank does not change significantly, and a further reduction of the flow will result in emptying the buffer tank before the high level has been reached. Therefore, this is considered as the lowest possible first constant flow for operation of the reactor chamber.

### EXAMPLE 4

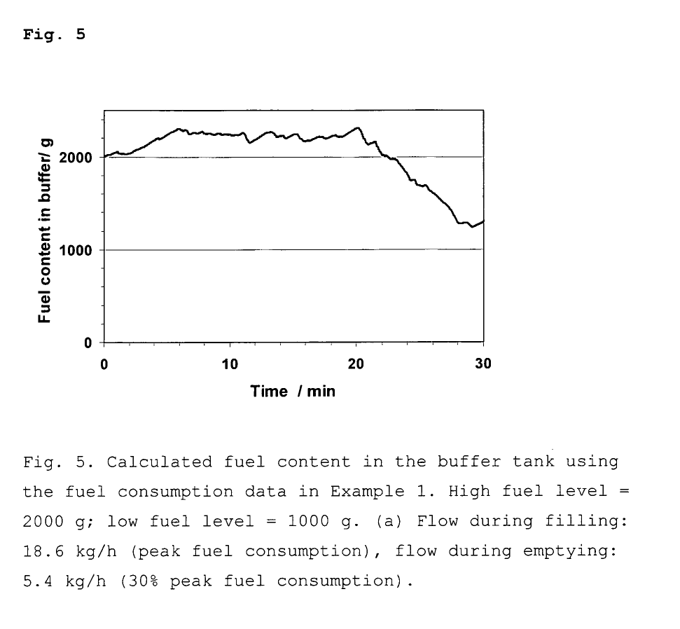

This example explores an upper limit for the flow during emptying the buffer tank. FIG. 5 shows the calculated fuel content in the buffer tank using a constant flow rate of 18.0 kg/h during filling and a flow rate of 5.4 kg/h corresponding to 30% of the peak fuel consumption determined in FIG. 1. In this example, there is an initial slight increase in fuel content in the buffer tank and a long period of time where the fuel content in the buffer tank is not changing significantly, while the level is slightly above the high level. Clearly, further increasing the second constant flow rate results in an increase in fuel content in the buffer tank during an extended period of time when it should be emptied. Therefore, this can be regarded as a maximum acceptable value for the second constant flow rate.

### EXAMPLE 5

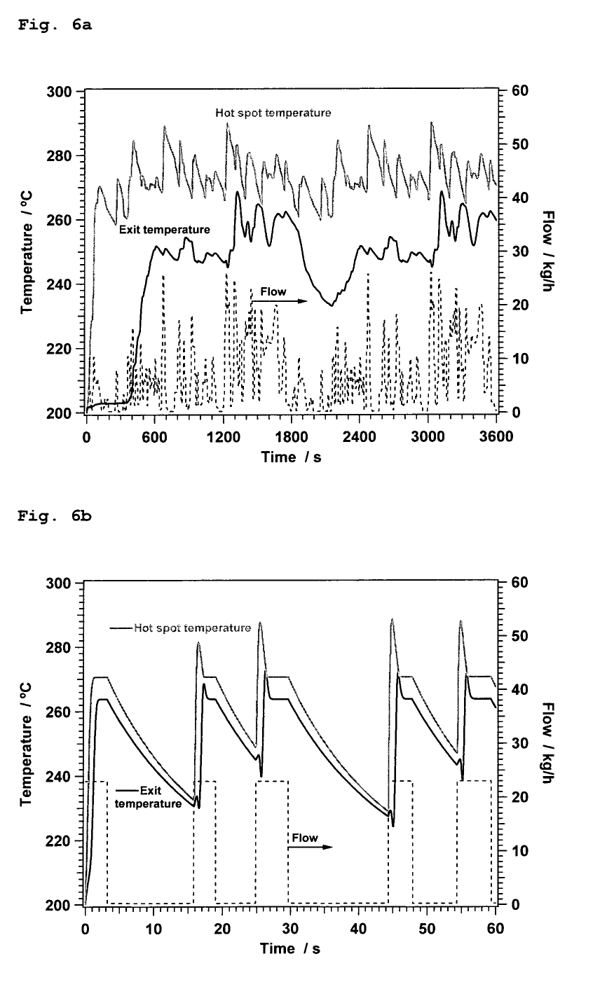

This example describes the effect of the invention on the temperature in the ethanol converter. Since the dehydration of ethanol to diethyl ether is exothermic a temperature profile in the reactor is established, and a hot-spot temperature about 80-90° C. above the inlet temperature can be expected dependent on the flow. FIG. 6a shows the calculated hot spot temperature, which is the maximum temperature in the reactor, if a reactor with 10 cm inner diameter and 25 cm long packed 2.0 kg with a ⅛″ trilobe extrudates of 60 wt % H-ZSM-5/40 wt % alumina catalyst with a performance as shown in FIG. 1 is operated with a flow that matches the momentary fuel demand of an engine. The inlet temperature of the reactor is 200° C., and the outer wall temperature (2 mm wall thickness) is kept at 200° C.; the pressure is 10 bar g. The momentary flow is calculated as described in FIG. 1, but with a time window of 10 seconds instead of 1 minute and the completed cycle is repeated once to simulate a one hour operation. The result is a very fluctuating hot spot temperature and outlet temperature of the reactor. The average hot spot temperature and exit temperature in the period 30-60 min. corresponding to long-term running conditions meaning that the effects of the initial heating are eliminated are 273 and 250° C., respectively. The total fuel demand of the engine during in the period 30 to 60 minutes is 3400 g implying that the total fuel production also is 3400 g in this period.

FIG. 6b shows the calculated hot-spot temperature and exit temperature for the same reactor as described above but operated according to the invention. The high fuel level for the buffer tank is 2000 g; the low fuel level is 1000 g. The predefined flow during filling is 23 kg/h, and the predefined flow during emptying the buffer tank is 0.23 kg/h. This corresponds to the situation depicted in FIG. 3b. The average hot spot temperature and exit temperature in the period 30 to 60 minutes are 257 and 249° C., respectively. Quite surprisingly, the total fuel production in the interval 30 to 60 minutes is 3390 g, which is essentially the same as in the operation with a demand-controlled flow in the converter (FIG. 6a). This means that by application of the invention the average hot spot temperature is reduced by 15° C. without a significant change in the average reactor exit temperature for the same amount of produced fuel.

As also is seen in FIG. 6b, the hot spot temperature increases rapidly to about 290° C. after a change from the low flow to the high flow, which is about the same as the maximum temperature level in FIG. 6a. However, by application of the invention the situation becomes predictable, since it will only occur if the flow is changed at the lower fuel level in the buffer tank. This means that proper precautions can be designed, e.g. an initially lower inlet temperature, to reduce the hot spot temperature further.

### EXAMPLE 6

This example shows the measured temperature profiles when a reactor is operated with alternately a low and a high flow of hydrous ethanol (95%). The reactor has an inner diameter of 100 mm inner diameter and contains 1.5 kg of an H-ZSM-5 based catalyst extrudates as described in Example 5 resulting in a catalyst bed height of 28 cm. The reactor is operated with a high flow of 9.3 kg/h and a low flow of 0.92 kg/h of hydrous ethanol, which is fed from the top of the reactor. The moments of changing the flow are in this example arbitrarily chosen to be 5 to 10 min at high flow conditions and 5-15 min. at the low flow conditions. The outer wall temperature is kept between 212 and 215° C.

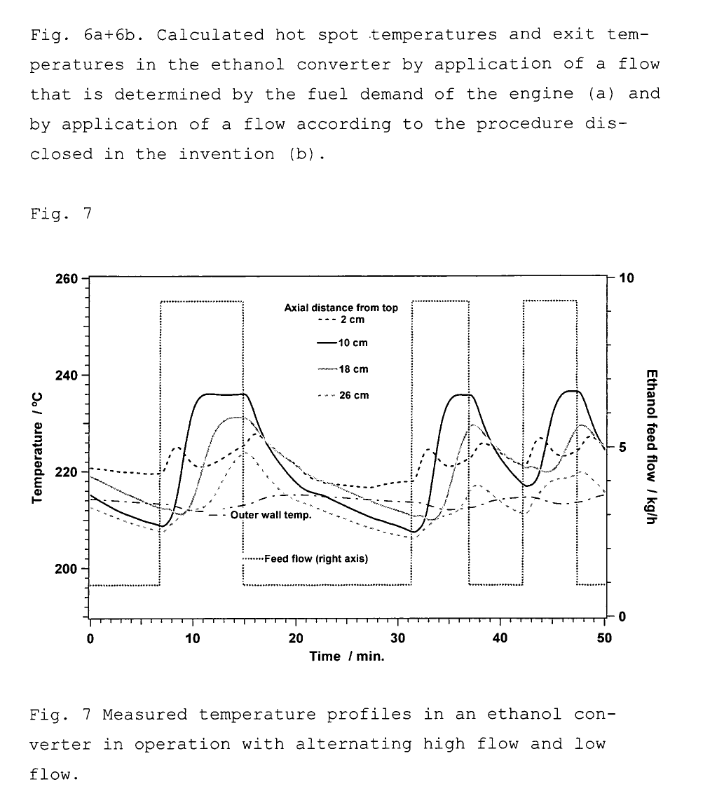

FIG. 7 shows the measured temperatures at 2, 10, 18, and 26 cm from the top of the reactor bed. The example shows the predictable response of the reactor to the change in flow from 0.92 to 9.3 kg/h and vice versa. The highest temperature in the reactor is 236° C. and is observed at 10 cm below the top of the bed. This temperature is reached 4 min. after changing the flow independent of the duration of the previous low flow phase.

1. A method of operating a compression ignition engine on diethyl ether containing fuel obtained by conversion of a primary ethanol containing fuel, comprising the steps of:
(a) withdrawing the primary ethanol containing fuel from a first fuel tank;
(b) introducing the primary ethanol containing fuel at a predetermined constant maximum flow rate into a reaction chamber with an alcohol dehydration catalyst;
(c) dehydrating the primary ethanol containing fuel to a diethyl ether containing fuel;
(d) passing the diethyl ether containing fuel to a second buffer tank up to a predetermined upper fuel level and interrupting introduction or reducing the flow rate of the primary ethanol containing fuel into the reaction chamber to a constant minimum flow rate being lower than the maximum flow rate when the upper fuel level in the reaction chamber is reached;
(e) withdrawing the diethyl ether containing fuel from the second buffer tank and injecting the diethyl ether fuel into the engine and emptying the second buffer tank to the predetermined lower fuel level;
(f) restarting introduction or re-establishing the constant maximum flow rate of the primary ethanol containing fuel into the reaction chamber when the predetermined lower fuel level is reached.

2. The method of claim 1, wherein the maximum constant flow rate is at least 70% of peak fuel consumption of the diethyl ether containing fuel.

3. The method of claim 1, wherein the minimum constant flow rate is from 0% to 30% of the peak fuel consumption of the diethyl ether containing fuel.

4. A system for use in the method of claim 1 comprising
a first fuel tank for holding a primary ethanol containing fuel;
an ethanol dehydration reactor connected to the first fuel tank at inlet of the reactor and to a second buffer tank connected at outlet of the reactor;
the second buffer tank holding a diethyl ether containing fuel being formed in the dehydration reactor is further connected to a compression ignition engine;
the second buffer tank is provided with at least a sensor for detecting an upper fuel level and at least a second sensor for detecting a lower fuel level in the buffer tank.
